(19) United States
(12) Patent Application Publication
(10) Pub. No.: US 2008/0288864 A1
(43) Pub. Date: Nov. 20, 2008

(54) METHOD AND SYSTEM TO ENABLE PRIORITIZED PRESENTATION CONTENT DELIVERY AND DISPLAY

(75) Inventors: Min Qu, Beijing (CN); Feng Li Wang, Beijing (CN); Xing Wei, Beijing (CN); Zheng Bao Zhang, Nanjing (CN)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: INTERNATIONAL BUSINESS MACHINES CORPORATION, Armonk, NY (US)

(21) Appl. No.: 12/116,511

(22) Filed: May 7, 2008

(30) Foreign Application Priority Data
May 15, 2007 (CN) 200710107483.5

(51) Int. Cl. G06F 17/00

(52) U.S. Cl. 715/273

(57) ABSTRACT

A method and device for content presentation are disclosed. The device receives one or more elements of content according to the priority setting thereof. The device displays the received elements. A sequence setter, responsive to a request for opening a remote slide file, is operable to receive an index of a set of slide objects for the slide file. The index comprises priority settings comprising a priority setting for each slide object within the set of slide objects and set a receive sequence based on the priority settings. A placeholder setter is operable to identify a subset of slide objects that have not been received and to replace the second subset of slide objects that have not been received with placeholders.

### FIELD OF THE INVENTION

The present invention relates to content presentation, and more particularly, to a method and device for content presentation.

### BACKGROUND OF THE INVENTION

Content presentation plays an important role for information delivery. Content presentation is usually implemented using a content presentation application in a computer, such as PowerPoint of Microsoft, Reader of Adobe, Freelance of IBM, etc. These applications present content to readers in the form of pages.

As the amount of information gets larger and larger and information is shared to a greater extent, a lot of content to be presented generally has a large size and is stored on remote servers. In the prior art, to browse content presentation stored on a remote server, a user has to first download all the content to a local disk and then to play the content by a content presentation application in the computer. In particular, when a user gets links of the presented content by the Internet search engine, the user often wants to browse the relatively important parts of the presented content and skip those trivial, so as to confirm that the presented content is really what he/she wants.

However, current presentation methods and devices do not have a mechanism to differentiate between important content and unimportant content. Additionally, users cannot set priority or presentation sequence for different classes of content during content presentation.

Another problem of presentation is that the size of a file where content presentation is located is usually large. For example, a file to be presented possibly includes image objects, video objects and audio objects, or the like. When users want to browse a presentation file, it usually takes a long time for them to find the important content of the content presentation. Sometimes only a small part of the whole file is useful. Therefore, much time is wasted on useless content by presenting all content or receiving all content completely via a network and presenting them.

### SUMMARY OF THE INVENTION

In view of the problems described above, the present invention provides a method and device for content presentation using priority.

It is an object of the present invention to reduce the time for presenting a remote and relatively large file, enhance the presentation efficiency and selectively present important content.

According to a first aspect of the present invention, there is provided a method for content presentation, which comprises the steps of: receiving one or more elements of content according to the priority setting thereof; and displaying the received elements.

According to a second aspect of the present invention, there is provided a method for content presentation, which comprises the step of displaying one or more elements of content according to the priority setting thereof.

According to a third aspect of the present invention, there is provided a device for content presentation, which comprises: a reception manager operable to receive one or more elements of content according to priority setting for said elements; and a display operable to display the received elements.

According to a fourth aspect of the present invention, there is provided a device for content presentation, which comprises a display operable to display one or more elements of content according to the priority setting for said elements.

Other features and advantages of the present invention will become apparent from the following detailed description of preferred embodiments illustrating the principles of the invention, when taken in conjunction with the accompanying drawings.

### BRIEF DESCRIPTION ON THE DRAWINGS

FIG. 1 is a flowchart for setting priority for elements of content using a method for content presentation according to an embodiment of the present invention;

FIG. 2 is a flowchart for presentation processing using a method for remote content presentation according to another embodiment of the present invention;

FIG. 3 is a flowchart for presentation processing using a method for local content presentation according to another embodiment of the present invention;

FIG. 4 is a block diagram of a device for remote content presentation according to another embodiment of the present invention; and

FIG. 5 is a block diagram of a device for local content presentation according to another embodiment of the present invention.

### DESCRIPTION OF THE PREFERRED EMBODIMENTS

The embodiments of the present invention will be described in detail.

It is to be understood that among the terms adopted in the present invention, elements may include: slide objects, which may be a slide, i.e. a page of the presented content, or which may be slide objects, such as text objects, image objects, video objects, audio objects, and other objects in an index-based file.

An index-based file means a file whose elements can be searched based on index. The set priority information may be included in the index. Or, when the priority information is not included in the index, the priority for the corresponding element may be set based on the index.

Content may include one or more index-based elements used for presentation to users. For example, content may be a presentation file established by a presentation application or a part of the presentation file.

A presentation application is an application capable of establishing, editing, and displaying content.

In the embodiment of the present invention, the priority setting may comprise two schemes as follows:

predefined priority setting: for predefining priority for different classes of objects. For example, plain text is predefined to have higher priority, while resource-consuming objects are predefined to have lower priority; and

user-defined priority setting: for setting priority based on users' preference.

In the embodiments of the present invention, users can use the predefined priority setting, the user-defined priority setting or a combination thereof as a scheme to set priority for the content to be presented.

In the embodiments of the present invention, the priority setting may be performed during content edition or before content presentation.

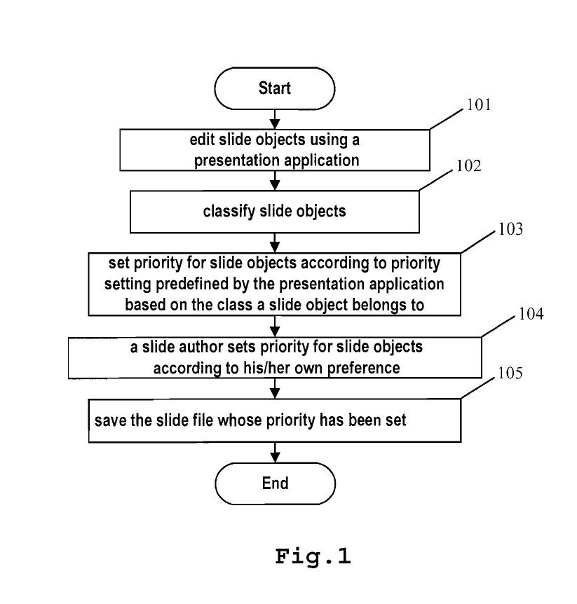

FIG. 1 is a flowchart for setting priority for elements of content using a method for content presentation according to an embodiment of the present invention. In the embodiment shown in FIG. 1, priority is set while content is edited. User-defined priority setting may be chosen on the basis of the utilization of priority setting predefined by a presentation application.

In step 101, a presentation application is run to edit a slide file which includes one or more slide objects, for example, includes one or slides each having one or more objects.

In step 102, the slide objects are classified. There are various classification methods. For example, a classification method may first obtain the index of, for instance, text objects, image objects, and audio objects in a slide, then classify, according to object types, these slide objects into categories, for instance, a category of text objects and a category of image objects, or a category of text-object-containing slides and a category of image-object-containing slides, or the like. Or a classification method may first obtain the index of slide objects and then classify the slides based on the fact whether or not the title of a slide contains some key words set by the slide author or predefined by a presentation application.

In step 103, based on priority setting predefined by the presentation application, priority is set for slide objects according to their respective classes.

In the presentation application, priority may be in a high-to-low sequence of 5, 4, 3, 2 and 1, or vice verse. Additionally, priority may also be 0 which indicates that no priority is set for the corresponding slide object.

In this embodiment, the priority for a text object may be predefined as 5 (the highest priority), the priority for an image object may be predefined as 4, the priority for an audio object may be predefined as 3, or the like. Therefore, when editing a slide file, the slide author can edit parts which are intended to catch the interest of slide readers as text objects and edit schematic parts as image objects. In this manner, the presentation application automatically sets the corresponding priority for each class of objects.

In step 104, the slide author can set priority for slide objects according to his/her own preference. This is an optional step. If the slide author wants the set priority to be different from the predefined priority setting in step 103, then he/she can rearrange and adjust the priority setting in step 104. In this embodiment, the slide author can set some exemplary text to have lower priority, for example, 2, and set some important images to have higher priority, for example, 5.

After steps 103 and 104, the priority for all or part of slide objects has been set possibly. In the case that there is no priority has been set for a part of slide objects, then priority for these slide objects may be set as 0. The priority setting information coming from steps 103 and 104 may be saved in the index of the file according to their corresponding slide objects, and also may be saved in other files or locations aside from the index. In this embodiment, priority setting information is saved in the index of the slide file.

In step 105, the edited slide file is saved on a storage medium. In this embodiment, the slide author can save the edited slide file remotely or locally so that slide readers can access it. In an example, readers can remotely access via network the slide file which is saved remotely. In another example, readers can directly access the slide file saved locally.

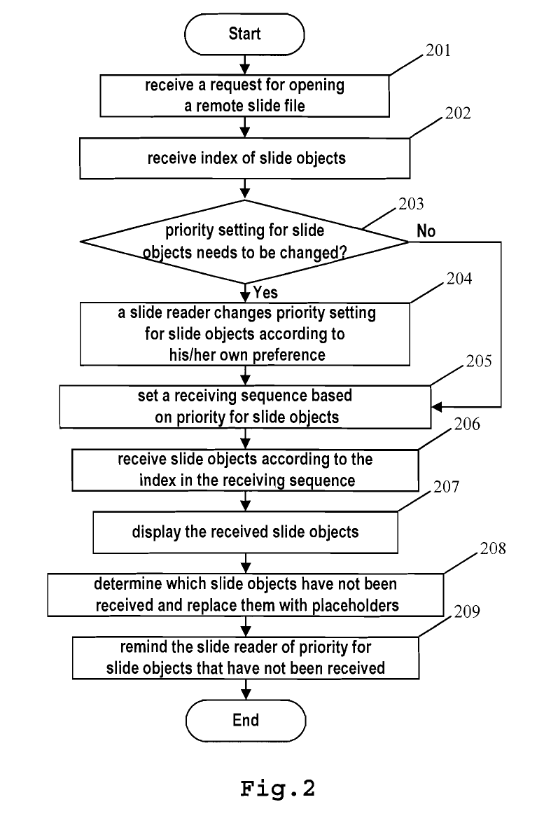

FIG. 2 is a flowchart for presentation processing using a method for remote content presentation according to another embodiment of the present invention.

This embodiment relates to presentation about product content which is a slide including general information and detailed technical terms. The slide author can set priority for content of a slide file according to the method shown in FIG. 1 during editing the slide file, for example, label one or more classes of slide objects in the slide file as emphases according to priority setting predefined by the presentation application. Optionally, based thereon, the slide author can set priority for necessary slide objects according to his/her own idea and preference. After finishing edition, the slide author saves the slide file on the storage medium, for example, a remote server.

Slide readers may include salesmen and technical engineers. When slide readers want to open this remote file, for salesmen who are not so strict about technical details, higher priority can be set for image-containing slide objects so that the product is preferably presented schematically; for those technical engineers, high priority can be set for slide objects containing detailed description and analysis of the product so that the product is preferably presented in terms of technical details. In this embodiment, content which is stored remotely can be presented dynamically according to different user needs and settings.

In step 201, a request for opening a remote slide file is received. In this embodiment, a slide reader chooses via the network a slide file which he/she wants to present and then prepares to open this file.

In step 202, the index of a slide object is received. In this embodiment, the index in a slide file may include the offset of a slide object in this file, the size of a slide object, the type of a slide object, and the priority setting information set during the edition of this slide file. Receiving this index is to obtain the priority setting information of a slide object and to facilitate the subsequent reception of the slide object according to the priority.

In step 203, it is determined whether or not the priority setting of the slide object needs to be changed based on the fact whether or not the received index contains priority setting information and based on the priority setting information per se. If yes, then the flow goes to step 204, otherwise goes to step 205.

In step 204, the slide reader changes priority setting of the slide object according to his/her own preference. The change may be to set an object having priority 0 to have certain priority, for example, the lowest priority 1. Also, the change may be to change priority for a certain class of slide objects to new priority, for example, to change priority for one class of slide objects having priority 2 to 4 without changing priority for other classes of slide objects having priority 2. Moreover, the change may be to change priority for one or more slide objects for which priority has been set to new priority, for example, to change priority for a certain class of slide objects having priority 3 to 5 (the highest priority) or 0.

In step 205, a receiving sequence for slide objects is set based on the priority for the slide objects. Schemes to set a receiving sequence of slide objects may include various schemes as follows:

A first scheme is to set a receiving sequence based on high-to-low priority (i.e. from 5 to 1) and last receive slide objects having priority 0 so as to receive all slide objects. In this manner, slide objects having higher priority are received earlier, and slide objects having lower priority are received later. Therefore, slide objects having priority 5 are first received, and slide objects having priority 4 are received subsequently, and slide objects having priority 3 are received afterwards, and so on.

A second scheme is to set a receiving sequence merely for slide objects having higher priority and thereby receive only part of slide objects. In this scheme, slide readers are reminded to set a priority threshold (for example, 3), so that a receiving sequence is set for merely slide objects having priority higher than the threshold while no receiving sequence is set for slide objects having priority lower than the threshold. If only those objects having priority 0 are not desired to be received, then the priority threshold can be set as 0, so that no receiving sequence is set for those objects.

In step 206, slide objects are received according to the index in the receiving sequence. Using the index and receiving sequence obtained in step 202 and step 205 respectively, slide objects are received in sequence from a remote storage to a local storage to be further displayed.

In step 207, received slide objects are displayed so that slide objects are presented in the receiving sequence.

If the receiving sequence is set for slide objects according to the first scheme in step 205, then all slide objects are displayed in this receiving sequence in step 207. For example, slide objects having priority 5 are first displayed, and slide objects having priority 4 are displayed subsequently, and slide objects having priority 3 are displayed afterwards, and so on.

If a receiving sequence is set for slide objects according to the second scheme in step 205, then slide objects having priority higher than the threshold (for example, 3) are displayed in this receiving sequence in step 207. For example, slide objects having priority 5 are first displayed, and slide objects having priority 4 are displayed subsequently, whereas slide objects having priority lower than or equal to 3 are not displayed.

Additionally, slide objects having different priority may be displayed in different manners. For example, for an object having higher priority, its background can be set as red or set to blink so as to make it more apparent and eye-catching.

In step 208, slide objects in the slide file, which have not been received, are determined and are then replaced by placeholders. Since slide objects that are in the front of the receiving sequence have arrived locally while slide objects that are in the back of the receiving sequence have not been received, those received slide objects, namely slide objects having higher priority, are first displayed. Slide objects that have not been received may be replaced by placeholders. As the slide objects having lower priority are further received, the placeholders may be placed by slide objects received subsequently.

In step 209, the slide reader is reminded of the priority for slide objects that have not been received and are thereby replaced by the placeholder, so that he/she has a better knowledge of priority for slide objects that have not been received.

The flow ends with the completion of presentation of slide objects.

In another embodiment of the present invention, after step 209, it is further determined whether or not the priority needs to be re-set for slide objects that have not been received. If yes, then priority is re-set for them, and step 205 to step 209 are repeated afterwards.

In still another embodiment of the present invention, the steps shown in FIG. 2 are performed according to existing priority that is associated with the slide object, while no priority is set for the slide object during edition thereof. That is to say, the steps shown in FIG. 1 are not performed. In addition, instead of step 204 of FIG. 2, the slide reader can set priority for the slide object according to priority setting predefined by the presentation application or his/her own preference.

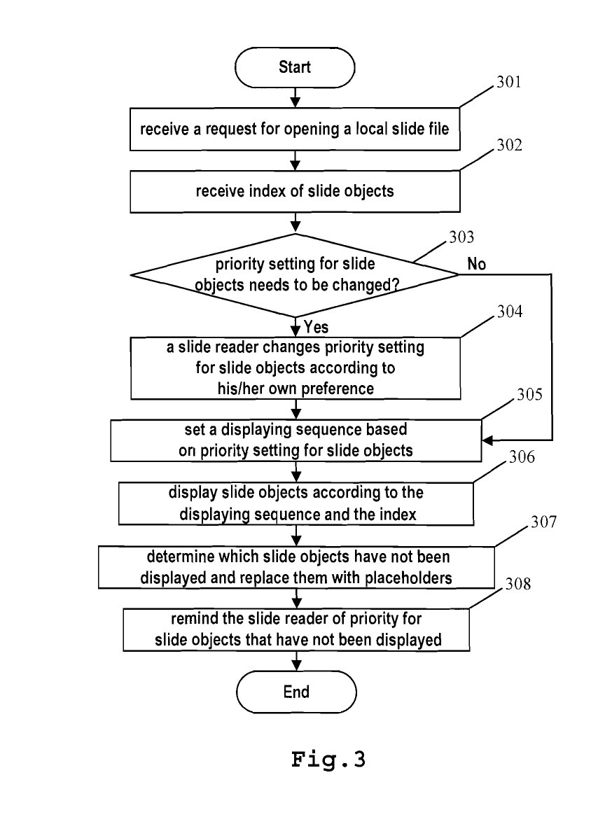

FIG. 3 is a flowchart for presentation processing with a method for local content presentation according to another embodiment of the present invention. In the embodiment illustrated in FIG. 3, the presented content is stored locally and is thereby displayed directly according to priority setting without performing the remote reception processing in the embodiment illustrated in FIG. 2. In this embodiment, priority setting of content is performed either prior to content presentation according to the method illustrated in FIG. 1, or during content presentation, wherein said priority setting may be user-defined priority setting or priority setting predefined by a presentation application.

In this embodiment, first, a slide author, e.g. a teacher, sets priority for slides using the method illustrated in FIG. 1 or according to his/her own idea and preference during editing the slide file. Optionally, the slide author may also set priority for slide objects according to the priority setting predefined by the presentation application. After the slide author finishes edition, he/she saves the slide file locally. Next, according to the method illustrated in FIG. 3, when the slide reader, a teacher or a student, opens the local slide file, elements having higher priority are displayed first. The flow of the method illustrated in FIG. 3 will be explained in detail below.

In step 301, a request for opening a local slide file is received. In this embodiment, a slide reader chooses a slide file which he/she wants to present and then prepares to open this file.

In step 302, the index of a slide object is received. In this embodiment, the index in a slide file may include the offset of a slide object in this file, the size of a slide object, the type of a slide object, and the priority setting information set during the edition of this slide file. Receiving this index is to obtain the priority setting information of a slide object and to facilitate the subsequent display of the slide object according to the priority.

In step 303, it is determined whether or not the priority setting of the slide object needs to be changed based on the fact whether or not the received index contains priority setting information and based on the priority setting information per se. If yes, then the flow goes to step 304, otherwise goes to step 305.

In step 304, the slide reader changes priority setting of the slide object according to his/her own preference. The change may be to set an object having priority 0 to have certain priority, for example, the lowest priority 1. Also, the priority for a certain class of slide objects may be changed to new priority, for example, the priority for one class of slide objects having priority 2 may be changed to 4 while the priority for other classes of slide objects having priority 2 is not changed. Moreover, the priority for one or more slide objects for which priority has been set may be changed to new priority, for example, the priority for a certain class of slide objects having priority 3 may be changed to 5 (the highest priority) or 0.

In step 305, a displaying sequence for slide objects is set based on the priority for the slide objects. Schemes to set a displaying sequence of slide objects may include various schemes as follows:

A first scheme is to set a displaying sequence based on high-to-low priority (i.e. from 5 to 1) and last display slide objects having priority 0 so as to display all slide objects. In this manner, slide objects having higher priority are displayed earlier, and slide objects having lower priority are displayed later. Therefore, slide objects having priority 5 are first displayed, and slide objects having priority 4 are displayed subsequently, and slide objects having priority 3 are displayed afterwards, and so on.

A second scheme is to set a displaying sequence merely for slide objects having higher priority and thereby display only part of slide objects. In this scheme, slide readers are reminded to set a priority threshold (for example, 3), so that a displaying sequence is set for merely slide objects having priority higher than the threshold while no displaying sequence is set for slide objects having priority lower than the threshold. If only those objects having priority 0 are not desired to be displayed, then the priority threshold can be set as 0, so that no displaying sequence is set for those objects.

In step 306, slide objects are displayed and according to the index in the displaying sequence. Slide objects are presented according to the index obtained in step 302 and in the displaying sequence set in step 305.

If the displaying sequence is set for slide objects according to the first scheme in step 305, then all slide objects are displayed in this displaying sequence in step 306. For example, slide objects having priority 5 are first displayed, and slide objects having priority 4 are displayed subsequently, and slide objects having priority 3 are then displayed, and so on.

If a displaying sequence is set for slide objects according to the second scheme in step 305, then slide objects having priority higher than the threshold (for example, 3) are displayed in this displaying sequence in step 306. For example, slide objects having priority are first displayed, and slide objects having priority 4 are displayed subsequently, whereas slide objects having priority lower than or equal to 3 are not displayed.

Additionally, slide objects having different priority may be displayed in different manners. For example, for an object having higher priority, its background can be set as red or set to blink so as to make it more apparent and eye-catching.

In step 307, slide objects in the slide file, which have not been displayed, are determined and are then replaced by placeholders. Slide objects that are in the front of the displaying sequence, namely slide objects having higher priority, are first displayed. Slide objects having lower priority are replaced by placeholders. As slide objects having lower priority are displayed, the placeholders may be placed by slide objects displayed subsequently.

In step 308, the slide reader is reminded of the priority for slide objects that have not been displayed and are replaced by the placeholders, so that he/she has a better knowledge of priority for slide objects that have not been displayed.

The flow ends with the completion of presentation of slide objects.

In another embodiment of the present invention, after step 308, it is further determined whether or not the priority needs to be re-set for slide objects that have not been displayed. If yes, then priority is re-set for them, and step 305 to step 308 are repeated afterwards.

In still another embodiment of the present invention, the steps shown in FIG. 3 are performed according to existing priority that is associated with the slide object, while no priority is set for the slide object during edition of the presentation file. That is to say, the steps shown in FIG. 1 are not performed. In addition, instead of step 304 of FIG. 3, the slide reader can set priority for the slide object according to priority setting predefined by the presentation application or his/her own preference.

In a further embodiment of the present invention, priority may be set for one or more objects of a slide while priority has been set for the slide. In this manner, an object having higher priority in a slide having higher priority is presented first, and an object having lower priority in a slide having higher priority is presented subsequently, and objects in a slide having lower priority are presented afterwards, and so on.

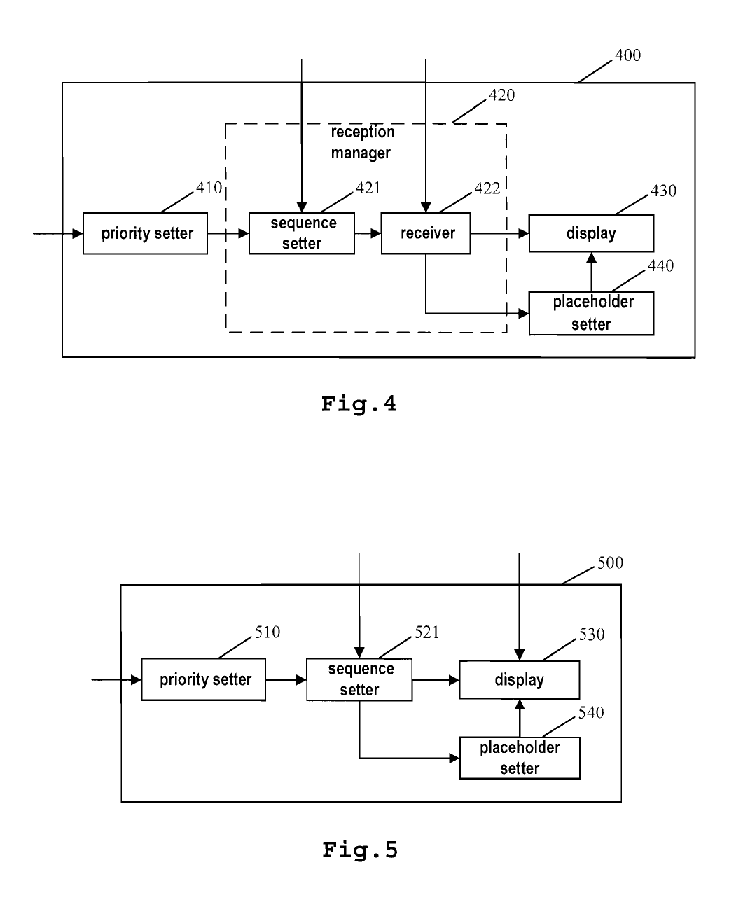

FIG. 4 is a block diagram of a device for remote content presentation according to another embodiment of the present invention. The device comprises: a reception manager 420 and a display 430. Further, the device may comprise a priority setter 410 and a placeholder setter 430.

Priority setter 410 operates to set priority for one or more elements of content, which comprises means for setting priority for elements of content according to priority setting predefined by a presentation application or priority setting preferred by a user during editing the content or before receiving the content. Priority setter 410 further comprises means for determining whether or not the priority needs to be re-set for elements that have not been received and means for re-setting priority for elements that have not been received when the priority is determined to be changed.

Reception manager 420 operates to receive one or more elements of content according to priority setting of said elements. Reception manager 420 comprises: a sequence setter 421 operating to receive index of elements and set a receiving sequence of the elements based on the priority for the elements of the content; and a receiver 422 operating to receive the elements according to the receiving sequence and the index of the elements.

Display 430 operates to display the received elements.

Placeholder setter 440 operates to determine which elements have not been received, replace those elements with placeholders and remind a slide reader of the priority for elements that have not been received.

FIG. 5 is a block diagram of a device for local content presentation according to another embodiment of the present invention. The device comprises a display 530. Further, the device may comprise a priority setter 510, a sequence setter 521 and a placeholder setter 540.

Priority setter 510 operates to set priority for one or more elements of content, which comprises means for setting priority for elements of content according to priority setting predefined by a presentation application or priority setting preferred by a user during editing the content or before displaying the content. Priority setter 510 further comprises means for determining whether or not the priority needs to be re-set for elements that have not been displayed and means for re-setting priority for elements that have not been displayed when the priority is determined to be changed.

Sequence setter 521 operates to receive the index of elements and set a displaying sequence of the elements based on the priority for elements of content.

Display 530 operates to display one or more elements of content according to the priority setting thereof. Specifically, display 530 displays elements according to the displaying sequence and the index of the elements.

Placeholder setter 540 operates to determine which elements have not been displayed, replace those elements with placeholders and remind a slide reader of the priority for elements that have not been displayed.

The method of the present invention can reduce the time for presenting a remote and relatively large file, enhance the presentation efficiency, and selectively present important elements. The advantages of the method of the present invention includes: selectively receiving or displaying content to be presented; quickly responding to a user request and thereby improving user experience; costing less resources, such as CPU, memory and bus; being independent of presentation standard and operating environment, and so on.

The present invention further relates to a computer program product including code for receiving one or more elements of content according to the priority setting for the elements and displaying the received elements.

The present invention even further relates to a computer program product including code for displaying one or more elements of content according to the priority setting for the elements.

Such a computer program product can be stored on a carrier.

While the foregoing has been with reference to specific embodiments of the invention, it will be appreciated by those skilled in the art that these are illustrations only and that changes in these embodiments can be made without departing from the principles of the invention, the scope of which is defined by the appended claims.

1. A computer implemented method for content presentation, comprising the steps of:
receiving a request for opening a remote slide file;
receiving an index of a set of slide objects for the slide file, wherein the index comprises priority settings comprising a priority setting for each slide object within the set of slide objects;
setting a receive sequence based on the priority settings;
receiving a first subset of slide objects within the set of slide objects according to the receive sequence such that slide objects having a priority below a priority threshold are not received;
displaying the first subset of slide objects;
identifying a second subset of slide objects that have not been received; and
replacing the second subset of slide objects that have not been received with placeholders.

2. The method according to claim 1, further comprising:
prior to setting the receiving sequence, resetting a priority for one or more slide objects within the set of slide objects.

3. The method according to claim 1, further comprising:
prior to receiving a request for opening a remote slide file, setting priority for the set of slide objects according to priority setting predefined by a presentation application or priority setting preferred by a user during editing said remote slide file or before receiving said remote slide file.

4. The method according to claim 1, wherein displaying the first subset of slide objects comprises:
displaying a third subset of slide objects within the first subset of slide objects having a highest priority setting in a different manner than a fourth subset of slide objects within the first subset of slide objects.

5-8. (canceled)

9. A device for content presentation, comprising:
a sequence setter, responsive to a request for opening a remote slide file, operable to receive an index of a set of slide objects for the slide file, wherein the index comprises priority settings comprising a priority setting for each slide object within the set of slide objects and set a receive sequence based on the priority settings; and
a receiver operable to receive said elements according to the receiving sequence and the index of said elements;
a reception manager operable to receive a first subset of slide objects within the set of slide objects according to the receive sequence such that slide objects having a priority below a priority threshold are not received;
a display operable to display the first subset of slide objects; and
a placeholder setter operable to identify a second subset of slide objects that have not been received and to replace the second subset of slide objects that have not been received with placeholders.

10. The device according to claim 9, further comprising:
a priority setter operable to, prior to setting the receiving sequence, reset priority for slide objects within the set of slide objects.

11. The device according to claim 10, wherein said priority setter comprises:
means for setting, prior to receiving a request for opening a remote slide file, priority for the set of slide objects according to priority setting predefined by a presentation application or priority setting preferred by a user during editing said remote slide file or before receiving said remote slide file.

12. The device according to claim 9, wherein the display is further operable to:
display a third subset of slide objects within the first subset of slide objects having a highest priority setting in a different manner than a fourth subset of slide objects within the first subset of slide objects.

13-17. (canceled)

18. The method according to claim 4, wherein the different manner comprises setting a display background to red.

19. The method according to claim 4, wherein the different manner comprises setting the third subset of slide objects to blink.

20. The device according to claim 12, wherein the different manner comprises setting a display background to red.

21. The device according to claim 12, wherein the different manner comprises setting the third subset of slide objects to blink.

22. A computer program product comprising a computer program stored on a computer readable medium which, when executed on a computer system, causes the computer system to:
receive a request for opening a remote slide file;
receive an index of a set of slide objects for the slide file, wherein the index comprises priority settings comprising a priority setting for each slide object within the set of slide objects;
set a receive sequence based on the priority settings;
receive a first subset of slide objects within the set of slide objects according to the receive sequence such that slide objects having a priority below a priority threshold are not received;
display the first subset of slide objects;
identify a second subset of slide objects that have not been received; and
replace the second subset of slide objects that have not been received with placeholders.

23. The computer program product according to claim 22, wherein the computer program stored on the computer readable medium further causes the computer system to:
prior to setting the receiving sequence, reset a priority for one or more slide objects within the set of slide objects.

24. The computer program product according to claim 22, wherein the computer program stored on the computer readable medium further causes the computer system to:
prior to receiving a request for opening a remote slide file, set priority for the set of slide objects according to priority setting predefined by a presentation application or priority setting preferred by a user during editing said remote slide file or before receiving said remote slide file.

25. The computer program product according to claim 22, wherein displaying the first subset of slide objects comprises:
displaying a third subset of slide objects within the first subset of slide objects having a highest priority setting in a different manner than a fourth subset of slide objects within the first subset of slide objects.

26. The computer program product according to claim 25, wherein the different manner comprises setting a display background to red.

27. The computer program product according to claim 25, wherein the different manner comprises setting the third subset of slide objects to blink.
